(19) United States
(12) Patent Application Publication
(10) Pub. No.: US 2018/0031190 A1
(43) Pub. Date: Feb. 1, 2018

(54) SCALABLE DIRECT LINE VOLTAGE LED LUMINAIRE TAPE

(71) Applicant: Richard Nicolai, St. James, NY (US)

(72) Inventors: Richard Nicolai, St. James, NY (US); Martin Gaon, Merrick, NY (US); Frank Zarcone, Smithtown, NY (US)

(21) Appl. No.: 15/221,766

(22) Filed: Jul. 28, 2016

(51) Int. Cl. F21S 4/28; F21V 23/02; F21V 23/06

(52) U.S. Cl. CPC F21S 4/28; F21V 23/06; F21V 23/02

(57) ABSTRACT

A lighting device includes a junction box and a power cord coupled to the junction box. A tape is connected to the junction box and is electrically coupled to the power cord. The tape includes light emitting diodes (LEDs) disposed in sections. Each section includes a repeating light engine block with the LEDs and a circuit repeat joint such that a dimension of the tape can be scaled by cutting the tape at a circuit repeat joint.

### BACKGROUND

### Technical Field

The present invention relates to light fixtures, and more particularly to light emitting diode (LED) fixtures configured in a tape, which can run off alternating current and provide a configurable length.

### Description of the Related Art

Traditional light emitting diode (LED) luminaires are typically powered by either internal or external drivers (power supplies) which convert alternating current (AC) line voltage to direct current (DC) voltage. These power supplies are costly, inefficient, bulky, power limited and typically have a mean time before failure (MTBF) of about 50,000 hours. Wattage of the power supply defines a maximum lumen output of the luminaire. A form factor of the power supply defines a minimum size and shape of the luminaire.

### SUMMARY

A lighting device includes a junction box and a power cord coupled to the junction box. A tape is connected to the junction box and is electrically coupled to the power cord. The tape includes light emitting diodes (LEDs) disposed in sections. Each section includes a repeating light engine block with the LEDs and a circuit repeat joint such that a dimension of the tape can be scaled by cutting the tape at a circuit repeat joint.

Another lighting device includes a junction box and an alternating current (AC) power cord coupled to the junction box. A flexible tape is connected to the junction box and is electrically coupled to the power cord. The tape includes a plurality of sections, each section including a repeating light engine block with a micro power supply, a circuit repeat joint and a plurality of light emitting diodes (LEDs), the tape having a customizable dimension that can be scaled by cutting the tape at a circuit repeat joint. An AC bus is disposed in the tape and is common to all sections to provide a single direct line power source feed to all the LEDs in the tape.

A method for configuring a lighting device includes providing a lighting device including a junction box, a power cord coupled to the junction box and a tape connected to the junction box and electrically coupled to the power cord, the tape including a plurality of light emitting diodes (LEDs) disposed in sections, each section including a repeating light engine block with the LEDs and a circuit repeat joint; and cutting the tape at a circuit repeat joint to scale a dimension of the tape.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is perspective view of a lighting device showing a power cord and a light emitting diode (LED) strip connected to a junction box in accordance with one embodiment;

FIG. 2 is a cross-sectional view of the LED strip showing a casing, LED module and wireways in accordance with one embodiment;

FIG. 3 is a top view of the lighting device with a cover removed from the junction box in accordance with one embodiment;

FIG. 4 is a magnified top view of the lighting device with the cover removed from the junction box showing the internal components of the junction box in greater detail in accordance with one embodiment;

FIG. 5 is a schematic diagram of LED circuitry showing repeating light engine blocks with the LEDs and a circuit repeat joint to scale a dimension of the tape by cutting the tape at a circuit repeat joint in accordance with one embodiment; and

FIG. 6 is a block/flow diagram showing a method for customizing LED tape in accordance with the present principles.

### DETAILED DESCRIPTION OF PREFERRED EMBODIMENTS

In accordance with the present principles, systems, devices and methods are disclosed for a scalable luminaire device that overcomes the limitations of conventional devices. In one embodiment, the luminaire device includes a tape having LEDs disposed therein. The LEDs may be formed in any configuration and may employ one or more colors. The tape can be cut to size. The tape connects to a low profile end junction box having a largest dimension about a same size as the tape. An AC cord exits the junction box and can be plugged into any standard wall outlet or hardwired to an electrical box, etc.

A scalable LED luminaire in accordance with the present principles breaks down the power supply into micro power supplies which are linked together through a common AC bus. The micro power supplies are preferably cascaded in parallel. This provides greater reliability and flexibility than conventional designs by repeating the luminaire light engine block along a length of the luminaire. Luminaires from inches to hundreds of feet can be realized in accordance with the present embodiments. The wattage and associated lumen output can scale from fractions of a watt to thousands of watts by cutting the luminaire to a desired length at the circuit repeat joints. By incorporating an internal AC bus a single feed can be employed to drive extremely long lengths of fixtures before another feed is needed. This feature reduces installation labor and drives installation cost to a minimal level when compared to conventional driver powered luminaires.

The luminaire in accordance with the present principles provides a flexible lighting system that promotes layout design flexibility, junction box termination and no driver to hide. This permits easy integration in architectural spaces by an installer. The luminaire may include multiple mounting options and applications, including an extrusion design, cove, ambiance, task lighting, etc. The flexible light engine enables the creation of decorative patterns and is dimensionally manageable. In one embodiment, 4 inches (or smaller) cut lengths are permitted to provide run length flexibility. In one embodiment, run lengths of 150′ or greater can be achieved from one voltage feed. The luminaire is also configured to permit digital dimming.

It is to be understood that the present invention will be described in terms of a given illustrative structure or architecture having illustrative circuit layouts; however, other architectures, structures, components and process features and steps may be varied within the scope of the present invention.

It will also be understood that when an element or component is referred to as being “on” or “over” another element, it can be directly on the other element or intervening elements may also be present. In contrast, when an element is referred to as being “directly on” or “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Spatially relative terms, such as “beneath,” “below,” “lower,” “above,” “upper,” and the like, may be used herein for ease of description to describe one element's or feature's relationship to another element(s) or feature(s) as illustrated in the FIGS. It will be understood that the spatially relative terms are intended to encompass different orientations of the device in use or operation in addition to the orientation depicted in the FIGS. For example, if the device in the FIGS. is turned over, elements described as “below” or “beneath” other elements or features would then be oriented “above” the other elements or features. Thus, the term “below” can encompass both an orientation of above and below. The device may be otherwise oriented (rotated 90 degrees or at other orientations), and the spatially relative descriptors used herein may be interpreted accordingly. In addition, it will also be understood that when a layer is referred to as being “between” two layers, it can be the only layer between the two layers, or one or more intervening layers may also be present.

It will be understood that, although the terms first, second, etc. may be used herein to describe various elements, these elements should not be limited by these terms. These terms are only used to distinguish one element from another element. Thus, a first element discussed below could be termed a second element without departing from the scope of the present concept.

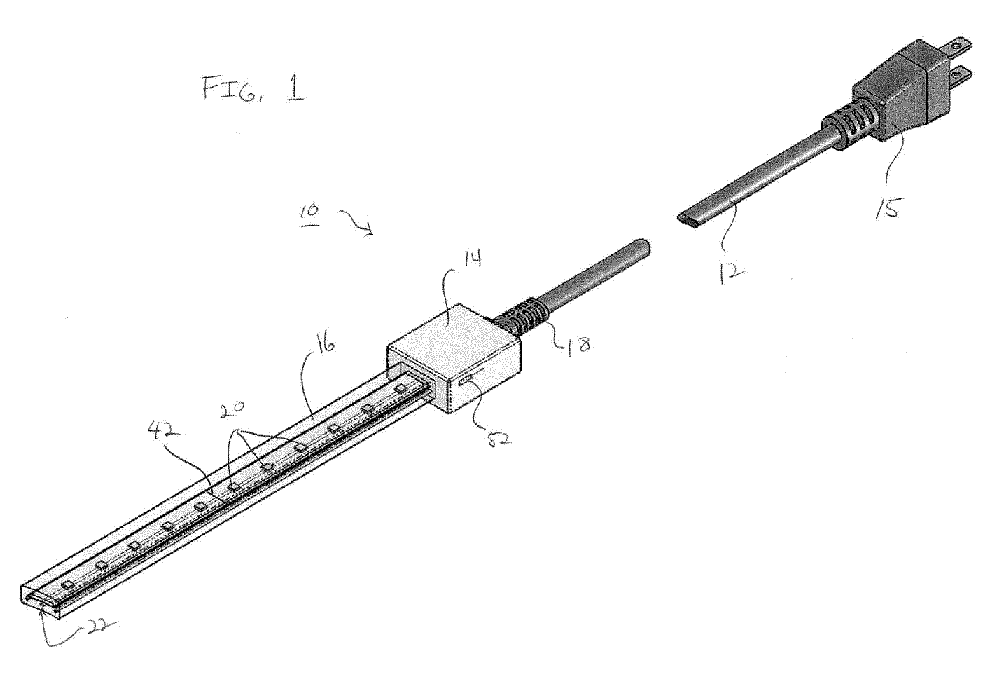

Referring now to the drawings in which like numerals represent the same or similar elements and initially to FIG. 1, a lighting device 10 is shown in accordance with one illustrative embodiment. The lighting device 10 may provide a luminaire structure in the form of a light emitting diode (LED tape or strip 16. The lighting device 10 includes an AC power cord 12 with a plug 15 configured to fit into any standard power outlet. The cord 12 connects to a junction box 14. The cord 12 may include a bend limiter or include a stress relief portion 18 at an interface with the junction box 14. The junction box 14 is configured to have a low-profile so that the junction box 14 does not impede placement and mounting of the device 10.

The lighting strip or strips 16 are connected to the junction box 14 and powered using the AC power cord 12. The power preferably includes a direct line voltage. The lighting strip 16 may include a linear array of light emitting diodes (LEDs) 20. The lighting strip 16 is configurable such that portions of the lighting strip 16 can be removed by cutting to provide a tailored length of the lighting strip 16 for effect lighting or other applications. In other embodiment, the lighting strip 16 is configured to permit removable portions to be as low as 4 inch sections. In another embodiment, removable portions include a multiple of 4 inch sections. In other embodiments, the section(s) may include other lengths or combinations of lengths. The LEDs 20 may be spaced apart in accordance with a design application. In one illustrative embodiment, the LEDs are spaced apart from between about ½ inches to about 2 inches. Other spacings are also contemplated.

The LEDs 20 may include any color and may include different sizes and intensities as per the design of the lighting strip 16 and application. In useful embodiments, the LEDs 20 may include lighting effects, such as blinking, sequential lighting, altered intensities, etc. An optional dimmer circuit 52 includes a slide for dimming the device 10. The end of the LED strip or tape 16 may include an end cap (not shown) to cover end portions of the tape 16 after it has been fabricated or after it has been cut.

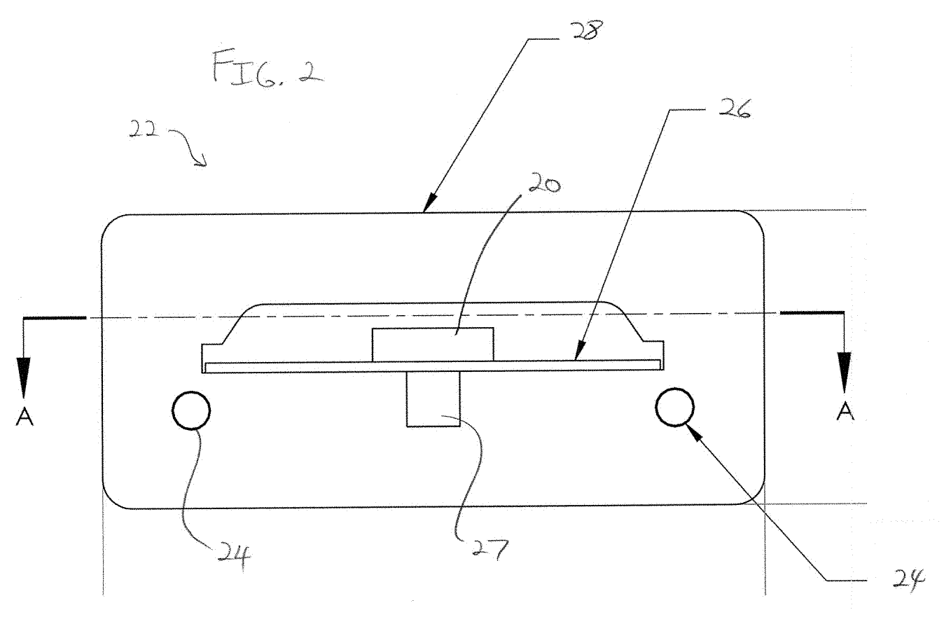

Referring to FIG. 2, a cross-sectional view of the lighting strip 16 is illustratively shown in accordance with one embodiment. The lighting strip 16 includes an LED module 26. The LED module 26 includes a flexible substrate, which may include a thermoplastic material, such as polyethylene, polyvinyl chloride, etc. LED circuitry is silk screened or deposited and etched onto the LED module 26. The LEDs 20 are mounted on or through the LED module 26 and soldered, riveted or otherwise electrically connected to the LED module 26 and the LED circuitry. The LED circuitry is connected to power wires disposed in wireways 24 formed on opposing sides of the LED module 26. The wireways 24 are electrically connected to the LED circuitry on the LED module 26. The lighting strip 16 includes a connection to the wireways 25 at least once within each removable section. For example, if the removable section size is 4 inches, the tape section 40 includes at least one connection to each wireway 24 within that removable section 40.

The LED module 26, the LEDs 20, and the wireways 24 are disposed within a casing 28. The casing 28 may include an extruded plastic strip or tube. In other embodiments, the casing includes a flexibly cured or molded material. In still other embodiments, the casing 28 may be applied using a curable or thermal material that is applied to pot or encapsulate the components to form the casings 28. The casing 28 may be transparent or colored. The casing 28 is preferably flexible to permit bending over a round surface or to be rolled up in a packaged state.

The casing 28 may include an optically clear material and include features (geometry) to disburse light at an angle of up to about 145 degrees. This can be achieved using geometrical shapes of the casing 28 or directing the LEDs 20. Other light angles are also contemplated. In one embodiment, an extruded encapsulation jacket (28) provides encapsulation for a light engine. The casing 28 may include a 5 VA flame barrier that also acts as a voltage isolation barrier incorporated for safety. A composite thermal plastic may be employed for the casing 28, which provides thermal dissipation through clear PVC material. F-1 rated materials for UV may be employed to eliminate discoloration and possible cracking and brittleness of the casing 28 over time. The casing 28 may include an extruded plastic jacket profile that provides numerous light distributions.

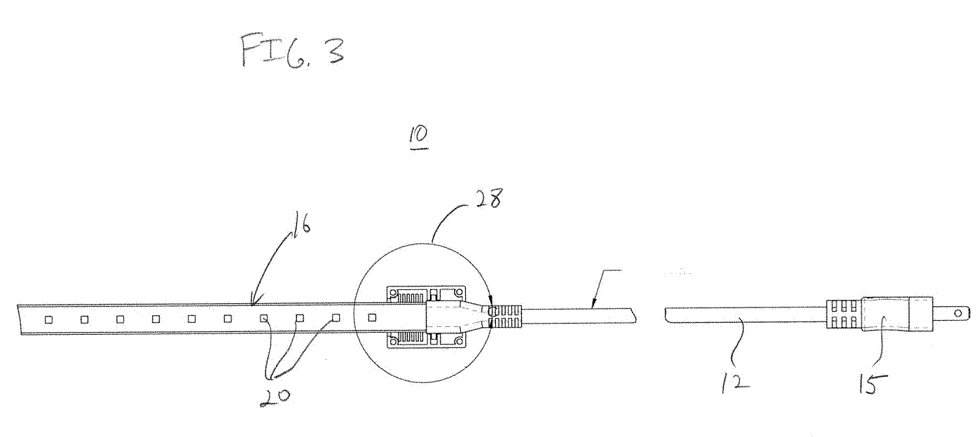

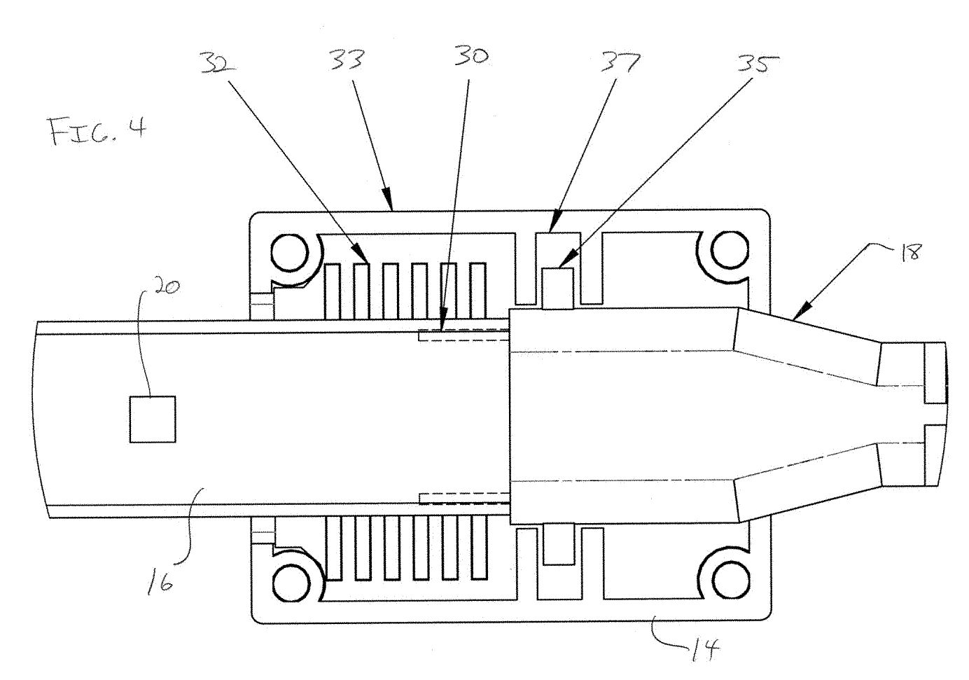

Referring to FIG. 3, a top view of the device 10 is shown with a cover removed from the junction box 14. A cover is removed from the junction box 14 to reveal structures and components therein. A detail 28 is depicted in FIG. 4 to show the internal portions of the junction box 14 in greater detail.

Referring to FIG. 4 with continued reference to FIG. 3, the junction box 14 may include a split-half or clam shell housing 33 with a cover (not shown) removed for illustrative purposes. Housing 33 of the junction box 14 may include a molded plastic material. The junction box 14 receives the relief portion 18 of the AC cord 12. The relief portion 18 may include flanges and/or torque stops 35 to prevent rotation and/or pullout of the cord 12 and relief portion 18 from the junction box 14 after being installed. The flanges and/or torque stops 35 fit within slot details 37 in the junction box 14. Safer operation is achieved by employing a mechanically fastened cord with tooled strain relief 18 (connector) to prevent a shock hazard.

The relief portion 18 further includes a connector that connects AC wires in the cord 12 to pins 30 in the LED strip 16. The pins 30 travel along the LED strip 16 in the wireways 24 of FIG. 2. In addition, ribs 32 are provided in the junction box 14 to grip the LED strip 16. The cover (not shown) includes similar features to the open junction box 14 including ribs (32), slot detail 37 and a portion to receive the relief portion 18.

During assembly, the junction box 14 is closed and secured using screws, snap together parts, rivets or other connecting devices. The ribs on the cover and the ribs 32 in the housing 33 are clamped down and grip the LED strip or tape 16. The cover and the housing 33 secure the LED strip 16 within the junction box 14. A sealant, such as an ultraviolet (UV) sealant compound, may be employed to coat the LED strip 16 and relief portion 18 to provide a water seal for the electrical components.

In one embodiment, a UV stabilized thermal plastic encapsulation jacket (thermoplastic polyurethane (TPU) or polyvinyl chloride ((PVC)) may be employed over the AC electrical parts (e.g., 15, 16) in the junction box 14.

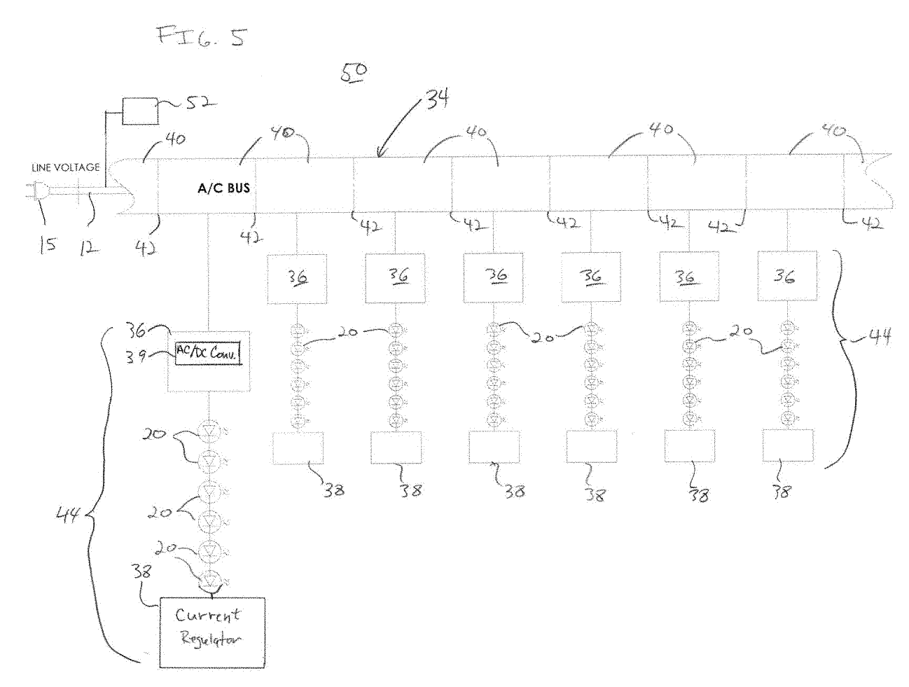

Referring to FIG. 5, a schematic diagram shows LED circuitry 50. The AC connector 15 receives line voltage and applied the voltage to an AC bus 34. Incoming line voltage is tapped from internal AC. The circuit is stepped and repeated along the length of the luminaire (lighting device 10) utilizing, in one embodiment, high voltage LEDs 20 which greatly reduces the LED string length providing extremely small circuit repeat lengths.

The AC bus 34 is segmented into sections 40. Each section 40 is connected to a plurality of LEDs 20 and a repeating light engine block 44 associated with that section 40. In one embodiment, each section 40 includes a 4 inch length and includes six LEDs 20. The sections 40 may include other lengths and other numbers of LEDs 20.

The LED circuitry 50 includes a plurality of micro power supplies 36, which are linked together through a common AC bus 34. The micro power supplies 36 are preferably cascaded in parallel. This provides greater reliability and flexibility than conventional designs by repeating the luminaire light engine block along a length of the LED strip 16. The sections 40 include circuit repeat joints 42 where the wattage and associated lumen output can scale from fractions of a watt to thousands of watts by cutting the luminaire to a desired length at the circuit repeat joints 42. In one embodiment, the output of the tape 16 may include 5.5 W per foot and 500 lumens per foot at 4000K/80 CRI (color rendering index). Other temperature and colors are also contemplated (e.g., 2700K, 300K, 3500K, 4000K, etc., RGB, RGBW settings, high CRI (90+), etc.).

By incorporating an internal AC bus 34, a single feed can be employed to drive extremely long lengths of fixtures before another feed is needed. This feature reduces installation labor and drives installation cost to a minimal level when compared to conventional driver powered luminaires.

The micro power supplies 36 connected to the AC bus 34 provide an AC to DC converter 39. The AC voltage is locally rectified and converted to DC voltage by the AC to DC converter 39, which includes a step down transformer 41 (e.g., 120 VAC to 5-20 VDC) and a rectifying circuit 43. The rectifying circuit may include one or more diodes. In one embodiment, a rectifying bridge may be employed. A fuse may also be employed to protect the LEDs 20.

Each segment 40 includes its own power supply 36 with A to D converter 39, its own LEDs 20 and its own current regulator 38. The string of LEDs 20 is current limited by the current regulator 38 which acts as a current limit switch. The A to D converter 39 provides rectification of the AC signal and transforms the higher AC voltage magnitude to a lower DC voltage suitable for powering the LEDs 20. The current regulator 38 is connected at an end of a chain of LEDs 20 to reduce and control the current flow through the LEDs 20. The LEDs 20 are connected in series or series parallel within each segment 40. The number of LEDs 20 is determined in accordance with a forward DC voltage.

The LED strip 16 can be broken up in accordance with sections 40 by severing the tape (strip 16) along the circuit repeat joints 42 to create an infinitely variable length LED luminaire. Cuttable length segments or sections 40 provide scalable light engines (44) from a single source (AC bus 34). The AC bus bar 34 is integrated into the tape 16 and is only converted to DC locally at the LED chain. By integrating the power source into the tape 16, each micro light engine 44 is powered independently. This increases the reliability of the total luminaire/device 10. The micro drivers or power supplies 36 are stepped and repeated in each section 40. The stepped configuration (each power supply 36 is connected along the AC bus 34) makes the wattage scalable and increases reliability. The LED circuitry 50 includes a capacitorless design with redundant circuits.

Once severed, the remaining unsevered sections 40 remain powered and include the same functions and operating parameters as the unsevered tape. In some embodiments, a dimmer circuit 52 may be provided on the LED strip 16 or in the junction box 14 and may be manually or automatically adjusted.

The embodiments described can provide greater reliability, and light output for in accordance with the present principles. The useful lifetimes of LEDs can far exceed the useful lifetimes of other bulbs. For example, LEDs can last for at least 100,000 hours or more.

The present principles may be employed in many applications. Some of these applications may include, e.g., cove lighting, hand rail illumination, slot fixtures, theater lighting, path of egress lighting, etc.

The repeat joints 42 may include demarcations for cutting the tape at the appropriate regions (between repeating light engine blocks). In one embodiment, the tape 16 can be torn by hand, cut by scissors or other tools. In other embodiments, the structure of the tape 16 is uniformly configured along its length. In still other embodiments, demarcations are placed inconspicuously (e.g., on the back of the tape 16).

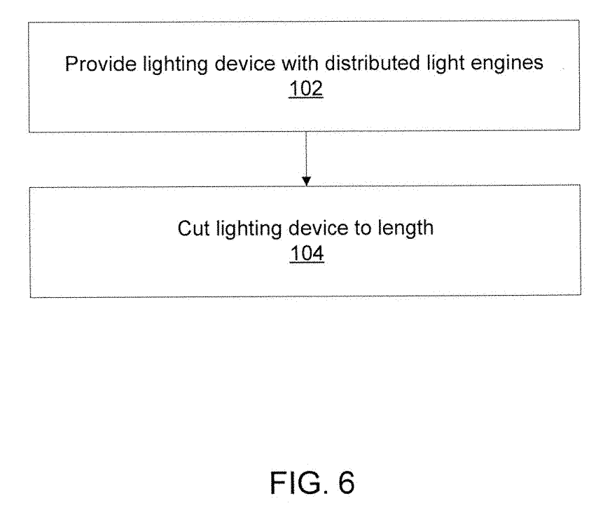

Referring to FIG. 6, a method for configuring a lighting device is shown in accordance with illustrative embodiments. In block 102, a lighting device is provided. The lighting device includes a junction box, a power cord coupled to the junction box and a tape connected to the junction box and electrically coupled to the power cord. The tape includes a plurality of light emitting diodes (LEDs) disposed in sections, each section including a repeating light engine block with the LEDs and a circuit repeat joint.

The repeating light engine block may include a micro power supply with an alternating (AC) to direct current (DC) converter and a rectifying circuit. The micro power supply distributes power from an AC bus running along a wireway in a casing of the tape.

In block 104, the tape is cut to length at a circuit repeat joint to scale a dimension of the tape. The tape is flexible and the circuit repeat joints are separated by about 4 inches. The tape is configurable between about 4 inches to about 150 feet from a single voltage feed.

Having described preferred embodiments for scalable direct line voltage LED luminaire tape (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A lighting device, comprising:
a junction box;
a power cord coupled to the junction box; and
a tape connected to the junction box and electrically coupled to the power cord, the tape including a plurality of light emitting diodes (LEDs) disposed in sections, each section including a repeating light engine block with the LEDs and a circuit repeat joint such that a dimension of the tape can be scaled by cutting the tape at a circuit repeat joint.

2. The lighting device as recited in claim 1, wherein the junction box includes a clam shell housing configuration with ribs on opposing sides to grip the tape.

3. The lighting device as recited in claim 1, wherein the power cord includes an alternating current (AC) power cord configured to receive AC power.

4. The lighting device as recited in claim 3, wherein the repeating light engine block includes a micro power supply with an AC to direct current (DC) converter and a rectifying circuit.

5. The lighting device as recited in claim 1, wherein the micro power supply distributes power from an AC bus running along a wireway in a casing of the tape.

6. The lighting device as recited in claim 1, wherein the tape is flexible and can bend over a rounded surface.

7. The lighting device as recited in claim 1, wherein the circuit repeat joints are separated by about 4 inches.

8. The lighting device as recited in claim 1, wherein the tape is configurable between about 4 inches to about 150 feet from a single voltage feed.

9. The lighting device as recited in claim 1, wherein the lighting device includes a dimmer circuit and the LEDs are dimmable.

10. A lighting device, comprising:
a junction box;
an alternating current (AC) power cord coupled to the junction box;
a flexible tape connected to the junction box and electrically coupled to the power cord, the tape including a plurality of sections, each section including a repeating light engine block with a micro power supply, a circuit repeat joint and a plurality of light emitting diodes (LEDs), the tape having a customizable dimension that can be scaled by cutting the tape at a circuit repeat joint; and
an AC bus disposed in the tape and common to all sections to provide a single direct line power source feed to all the LEDs in the tape.

11. The lighting device as recited in claim 10, wherein the junction box includes a clam shell housing configuration with ribs on opposing sides to grip the tape.

12. The lighting device as recited in claim 10, wherein the micro power supply includes an AC to direct current (DC) converter and a rectifying circuit.

13. The lighting device as recited in claim 10, wherein the micro power supply distributes power from an AC bus running along a wireway in a casing of the tape.

14. The lighting device as recited in claim 10, wherein the circuit repeat joints are separated by about 4 inches.

15. The lighting device as recited in claim 10, wherein the tape is configurable between about 4 inches to about 150 feet.

16. The lighting device as recited in claim 10, wherein the lighting device includes a dimmer circuit and the LEDs are dimmable.

17. A method for configuring a lighting device, comprising:
providing a lighting device including a junction box, a power cord coupled to the junction box and a tape connected to the junction box and electrically coupled to the power cord, the tape including a plurality of light emitting diodes (LEDs) disposed in sections, each section including a repeating light engine block with the LEDs and a circuit repeat joint; and
cutting the tape at a circuit repeat joint to scale a dimension of the tape.

18. The method as recited in claim 17, wherein the repeating light engine block includes a micro power supply with an alternating (AC) to direct current (DC) converter and a rectifying circuit and the micro power supply distributes power from an AC bus running along a wireway in a casing of the tape.

19. The method as recited in claim 17, wherein the tape is flexible and the circuit repeat joints are separated by about 4 inches.

20. The method as recited in claim 17, wherein the tape is configurable between about 4 inches to about 150 feet from a single voltage feed.
